(19) United States
(12) Patent Application Publication
(10) Pub. No.: US 2010/0285301 A1
(43) Pub. Date: Nov. 11, 2010

(54) Breathable Membranes and Method for Making Same

(76) Inventors: Marie Dieudonné, Chalette Sur Loing (FR); Natacha De Dominicis, Ferrieres-En-Gatinais (FR); Philippe Sonntag, Hericy (FR)

Correspondence Address: MORGAN LEWIS & BOCKIUS LLP, 1111 PENNSYLVANIA AVENUE NW, WASHINGTON, DC, 20004, US

(21) Appl. No.: 12/742,060

(22) PCT Filed: Nov. 7, 2008
(86) PCT No.: PCT/FR08/01577

§ 371 Date: Jul. 27, 2010

(30) Foreign Application Priority Data
Nov. 9, 2007 (FR) 07 07865

(51) Int. Cl. D06M 10/08; B05D 7/24; C08J 7/00; D06M 10/02; D06M 14/18

(52) U.S. Cl. 428/315.5; 427/535; 427/539; 427/569; 427/538; 428/421; 428/327; 428/336

(57) ABSTRACT

The invention relates to a method for modifying the surface of a membrane by plasma treatment, wherein said method imparts water-repellent and imperviousness properties to said membrane while preserving the steam perviousness and the elastic properties thereof. The method comprises, inter alia, a step of treating the membrane with a plasma of a precursor compound selected from a hydrocarbon gas, a fluorocarbon gas, mixtures thereof, a fluorocarbon liquid, a fluorocarbon solid, wherein the precursor compound is selected in such a way that the F/C ratio is lower than 2, followed by a step of treating the same surface of the substrate from the previous step with a plasma of a fluorocarbon gas selected in such a way that the F/C ratio is at least 2. The invention also relates to the resulting membranes.

The subject of the invention is a novel process for modifying the surface of a membrane, this process making it possible to confer on said membrane water repellency and impermeability properties while maintaining its water vapor permeability and its elastic properties.

The subject of the invention is also the membranes obtained by this process.

For various applications, such as for sports clothing and rubber gloves, but also for fuel cell membranes and ultrafiltration membranes, there is a need for films that are impermeable to water in the liquid state but are permeable to water vapor, especially in the case of clothing articles, to avoid the accumulation of water vapor resulting from transpiration. Articles possessing these two properties are referred to as breathable water-repellent articles.

Currently, there are two processes for manufacturing breathable water-repellent films: coating of a membrane on a fabric and lamination of a membrane onto a fabric.

The coating process applies a coating directly to the fabric, which obstructs the spaces between the yarns of the woven cloth to make the fabric impermeable. To maintain breathability, a paste is applied which, after “curing”, causes micropores to appear by solvent evaporation. Most microporous coatings are based on polyurethanes. Examples of such films are illustrated in U.S. Pat. No. 4,774,131; U.S. Pat. No. 5,169,906; U.S. Pat. No. 5,204,403 and U.S. Pat. No. 5,461,122.

Breathable water-repellent membranes are most of the time supported on a textile material. This is especially because of the poor mechanical properties of known breathable water-repellent membranes, since they have to be fine (5 to 50 microns) in order to maintain good breathability properties. There are two types of breathable water-repellent membranes: hydrophilic membranes and microporous membranes. A microporous membrane consists of micropores allowing water vapor to pass through it but blocking the water droplets. The removal of moisture (transpiration) takes place via a physical action, whereas in hydrophilic membranes moisture transfer takes place via a chemical phenomenon. The membrane absorbs water vapor and rejects it to the outside. In this case, the pump has to be primed, i.e. the membrane must firstly be engorged with water in order to operate. In both cases, it is the pressure difference that activates moisture evacuation. A microporous film has a tendency to evacuate water vapor more quickly but no longer transfers water in liquid form.

Although the films of the prior art have advantageous water impermeability and vapor permeability properties, they generally have a major defect, namely poor mechanical properties and especially a low elasticity; moreover, the membranes are very often adhesively bonded to the supports, thereby adding other problems such as possible delamination and further limiting the breathability properties, since the adhesive does not always breath sufficiently.

There therefore remains the need for a process for obtaining breathable water-repellent membranes having satisfactory repellency properties and also good elasticity without modifying the mechanical properties of the support, these characteristics furthermore being durable over time.

Membranes having these properties are obtained by a plasma treatment on a suitable support, this treatment enabling a layer of a nanostructured crosslinked amorphous polymer to be deposited which lets water vapor pass through it, which is very hydrophobic and impermeable to water in liquid form, and which is elastic.

Such a treatment may be carried out by exposing a precursor (whether a gas, liquid or solid) to an energy source so as to make said precursor pass into an excited state and produce ionized species that will be deposited on the substrate. The ionized species may be produced by treating the precursor by PECVD (plasma-enhanced chemical vapor deposition), by LECVD (laser-enhanced chemical vapor deposition), by PVD (physical vapor deposition), by reactive PVD, by sputtering or by any other plasma deposition technique. The preferred mode of producing ionized species is RF (radio frequency)-PECVD treatment.

It is known from the prior art to modify a polymer membrane by a plasma treatment so as to give it expected hydrophilic or hydrophobic properties.

Document WO 02/04083 describes polymer membranes made hydrophilic by a plasma treatment. Although this mentions the possibility of making the membranes hydrophobic, it includes no practical information for this purpose—it neither mentions the possibility of obtaining a membrane which is both hydrophobic and permeable to water vapor, nor the possibility of obtaining by this process membranes having good elasticity properties. The process described is an H₂O plasma treatment which results in the formation of oxidizing agents (H⁺, O₂, O⁻, O₃, H₃₀⁺). These oxidizing agents modify the surface of the support exposed to their action, making it hydrophilic. The substrate to be treated is placed outside the reactor where the plasma forms and is subjected to a flux coming from the reactor. Such a process does not in general allow layers of material to be deposited on a substrate, rather it modifies the properties of this substrate through the action of the ionized species.

Document WO 02/100928 describes the deposition of a polymeric coating on an elastomer material. The process employed, which includes the use of low pressures, results in the formation of continuous films that are very highly crosslinked and impermeable to water vapor.

Various plasma treatment methods are used for obtaining what are called ultrahydrophobic surfaces. For example, K. Teshima et al., Applied Surface Science, 2005, 244(1-4), 619-622 show that the plasma treatment of polyethylene terephthalate sheets makes it possible to obtain ultrahydrophobic surfaces. This two-step treatment firstly consists in treating the surface with an oxygen plasma, so as to introduce nanostructuring into it then in plasma-treating the resulting surface (using RF-PECVD) with an organosilicone liquid precursor in order this time to introduce hydrophobic groups. Another, more general method involves the microwave plasma deposition of a liquid mixture: an organosilane, an organosilicone (A. Hozumi and O. Takai, Thin Solid Films, 1997, 303(1-2), 222-225) or the plasma deposition of an organosilicone compound to which another gas is added followed by the chemical grafting of fluorosilane-type compounds (A. Nakajima et al., Thin Solid Films, 2000, 376(1-2), 140-143; Y. Wu et al., Thin Solid Films, 2004, 457(1), 122-127; Y. Wu et al., Thin Solid Films, 2002, 407(1-2), 45-49). All these coatings have water contact angles greater than 140°. They all require in general very long treatment times (>15 minutes) and are not permeable to water vapor.

Compared with the processes of the prior art, the process of the invention is simple, does not require the use of chemical reaction steps in addition to the precursor ionization treatment, especially plasma treatment, and results in very hydrophobic products, yet the coating obtained is itself permeable to gases and especially to water vapor. This process is rapid and gives a coating having elastic properties. The hydrophobicity and water vapor permeability properties are maintained upon stretching the support and after the stress has been removed.

The invention relates to a process for manufacturing a breathable water-repellent membrane, characterized in that:
(i) a support layer consisting of a film or a membrane made of a gas-permeable material is used;
(ii) optionally, this support layer is subjected on at least one of its faces to at least one treatment chosen from:
   a plasma treatment using the plasma of a gas chosen from: argon, oxygen, helium and mixtures thereof and
   a chemical cleaning step;
(iii) the film or the membrane coming from step (i) or from step (ii) is subjected on the same face to a plasma treatment using a plasma of a precursor compound chosen from: a hydrocarbon gas, a fluorocarbon gas and hydrocarbon gas/fluorocarbon gas mixtures; a fluorocarbon liquid; and a fluorocarbon solid, the precursor compound being chosen in such a way that F/C<2; and
(iv) the film or the membrane coming from step (iii) is subjected on the same face to a plasma treatment using a plasma of a fluorocarbon gas, this fluorocarbon gas being chosen in such a way that it has an F/C ratio ≧2.

The plasmas used in the process of the invention are preferably DC or pulsed (radio frequency (13.56 MHz), low-frequency or microwave) plasmas or magnetron-generated plasmas. They may also result from the treatment of a gaseous or liquid precursor by PECVD (plasma-enhanced chemical vapor deposition) or LECVD (laser-enhanced chemical vapor deposition) or of a solid precursor by PVD (physical vapor deposition), by sputtering or by any other plasma deposition technique. The preferred deposition method is PECVD.

The support layer used in the process of the invention may be a membrane made of a polymer material, a nonwoven textile material, a woven or knitted fibrous material, a composite i.e. a material based on a polymer and at least one material chosen from natural and synthetic fibers, cellulose and cellulose derivatives. Preferably, the support layer consists of a nonwoven or a membrane made of a polymer or made of a composite. Such a membrane may include a breathable adhesive layer on the surface.

When the support layer is a membrane made of a polymer material or made of a composite, it is advantageously chosen from materials that are permeable to gases and especially to water vapor. This is the case of hydrophilic microporous membranes that allow water vapor to pass through them via a molecular diffusion mechanism.

Membranes made of a polymer material or a composite may in particular include membranes made of an elastomer material and membranes coming from a blend of polymers, at least one of the components of which is an elastomer.

Among microporous membranes, mention may in particular be made of membranes made of a polyolefin, PTFE, polyurethane or PES (polyethersulfone) such as those described in particular in U.S. Pat. No. 4,833,026, U.S. Pat. No. 5,908,690 and EP-0 591 782.

In particular, microperforated membranes may be mentioned, namely Transpore® films (from 3M) and One Vision® microperforated films (sold by Diatrace).

Among hydrophilic membranes, mention may in particular be made of modified polyesters, modified polyamides, and biopolyesters (PHA: polyhydroxyalkanoate and PLA: polylactic acid).

Nonwoven textile materials that may be mentioned include: nonwovens based on Vistamaxx® (from Exxon), Elaxus® nonwovens (from Global Performance Fibers) and Curaflex® and Curastrain® nonwovens sold by Albi Nonwoven.

Woven or knitted fibrous materials that may be mentioned include those sold by Tissages de l'Aigle under the references 1148, 1144 and 3600.

The materials that can be used according to the invention as support for the coating are materials that are permeable to gases, preferably permeable to polar gases. The invention relates most particularly to support materials that are permeable to water vapor. Advantageously, the films or membranes constituting the support material of the invention have a water vapor permeability equal to or greater than 250 g of water vapor per square meter per day, measured according to the ASTM E96 standard, method B.

Advantageously, they have good elasticity and in particular a tensile set after a 50% elongation, measured according to the ISO 2285 standard, of 10% or less.

In general, any film or membrane of a material satisfying these two properties constitutes a preferred support for implementing the invention. These films or membranes may be isotropic or anisotropic.

According to the invention, all of the support layer, or only a portion thereof, may be covered with the plasma coating.

The process of the invention is advantageously implemented in a direct plasma reactor, i.e. a plasma reactor in which the substrate is placed in the chamber in which the reactive species are formed, unlike remote plasma processes in which the plasma is formed in the reactor and then conveyed therefrom to the substrate in the form of a flux of ionized species.

A direct plasma reactor usually comprises:
an excitation system, comprising a generator delivering electromagnetic waves;
an aluminum chamber comprising an electrode and a counter electrode. One electrode is directly connected to the generator—generally the chamber serves as counter electrode. The shape of the electrode is adapted according to the type of product to be treated; and
a pumping system.

Although any method and all means for generating a gas plasma can be used to implement the invention, such as those described above, it is preferable to choose a radio frequency direct plasma reactor.

The treatment is usually carried out at a temperature between 20 and 350° C., advantageously between 20 and 50° C.

The treatment is usually carried out at a pressure between 0.05 and 10 mbar, advantageously between 0.2 and 1 mbar.

According to the process of the invention, several compounds are employed in succession in order to generate a plasma that modifies the surface of the membrane or of the support film.

Step (ii) is optional. It is intended for cleaning the surface of any impurities and for activating said surface, which in particular results in radicals appearing on the surface of the substrate. Depending on the surface finish of the support, step (ii) may be omitted. When a chemical cleaning operation is carried out, this may consist in treating the face of the support to be treated, for example using solvents.

Preferably, according to the invention, the support layer is subjected in step (ii) to an argon plasma treatment. Advantageously, the power P for carrying out this step is proportional to the useful area of the cathode. The power P is advantageously between 0.1 and 2 W/cm². As an illustration, for an electrode measuring 20 cm×20 cm, a power of between 50 and 250 W is employed. The power is adapted according to the nature of the substrate. Advantageously, the treatment time t for carrying out this step is between 50 and 150 s and the gas flow rate Q depends on the volume of the chamber, the pressure therein being between 0.3 and 0.6 mbar.

Among the gases that can be employed in step (iii), mention may be made of the following: C₁-C₁₀ alkanes; C₂-C₁₀ alkenes; C₂-C₁₀ alkynes; C₁-C₁₀ fluoroalkanes; C₁-C₁₀ fluoroalkenes; fluorine-containing and sulfur-containing gases, such as for example C₂H₂, CF₄, CH₄, CHF₃, C₃F₈ and SF₆. Advantageously, the gas employed in step (iii) is a C₂H₂/CF₄ mixture. Advantageously, the gas or gas mixture employed in step (iii) is a C₂H₂/CF₄ mixture with a volume ratio such that 2≦C₂H₂/CF₄≦5.

Among liquids that can be used as precursor in step (iii), mention may be made of fluoroacrylates and fluoromethacrylates.

Among solids that can be used as precursor in step (iii), mention may be made of the following: PTFE (polytetrafluoroethylene), ETFE (ethylene-tetrafluoro-ethylene copolymer), PVF (polyvinylfluoride), PVDF (polyvinylidenefluoride), FEP (fluorinated ethylene-propylene copolymer) and PFA (perfluoroalkoxy copolymer).

Advantageously, the power P for carrying out this step is proportional to the useful area of the cathode. The power P is advantageously between 0.04 and 2 W/cm². The treatment time t is between 30 and 150 s and the gas flow rate Q depends on the volume of the chamber, the pressure therein being between 0.1 and 0.4 mbar.

Advantageously, the gases employed in step (iv) have an F/C ratio equal to or greater than 2. Among gases that can be employed in step (iv), mention may be made of CF₄, CHF₃ and C₃F₈. Preferably, CF₄ is chosen. Advantageously, the power P in this step is proportional to the useful area of the cathode. The power P is advantageously between 0.2 and 3 W/cm². The treatment time t is between 50 and 300 s, preferably between 140 and 190 s, and the gas flow rate Q depends on the volume of the chamber, the pressure therein being between 0.25 and 0.6 mbar. This step is used to structure and fluorinate the previously deposited layer. It makes the product both hydrophobic and repellent.

Another subject of the invention is a membrane that can be obtained by the process of the invention, which membrane is distinguished by the fact that it is a breathable water-repellent membrane.

The membranes having these properties are obtained thanks to the treatment of a support, this treatment enabling a layer of a nanostructured crosslinked amorphous polymer to be deposited, which lets water vapor pass through it, which is water-repellent, i.e. impermeable to water in liquid form, and which is elastic.

A nanostructured polymer layer comprises:
an assembly or aggregate of nano-sized particles linked together by covalent bonds and/or by van der Waals bonds, this assembly forming a relatively porous layer, the porosity of which depends on the “compacting” density of these particles,
   or
a nanoporous polymeric network, i.e. one provided with nano-sized pores.

Such a membrane includes at least one support layer in the form of a membrane or a film, such as those described above, and at least one layer of a plasma coating consisting of a nanostructured crosslinked amorphous polymer composed of C, H, F and optionally O, the C/F molar ratio being between 1.5 and 2.5, this layer having:
carbon-containing functional groups, in particular functional groups chosen from: —CH₂—, —CH═CH— and —CH₃;
fluorine-containing functional groups, and in particular functional groups chosen from: —CH₂F, —CF₃—CF₂, —CF═CF—, —FC═CF₂, and —HC═CF₂; and
optionally, carbonyl functional groups (—C═O).

This layer may be in the form of nanoparticles with a size of between 10 and 500 nm, preferably between 50 and 150 nm. These nanoparticles may or may not be assembled together and they form a porous film with pore sizes ranging from 10 to 200 nm, preferably from 20 to 100 nm. They may be in the form of a nanoporous polymer film with pore sizes ranging from 10 to 200 nm, preferably from 20 to 100 nm. The layer is bonded to the substrate via covalent and/or ionic and/or van der Waals bonds. The thickness of the layer may range from 20 to 1000 nm, advantageously from 40 to 100 nm.

The membranes of the invention have the advantage of being impermeable to water, permeable to water vapor, of being provided with water repellency properties, of being elastic and of being provided with good abrasion resistance.

The term “elasticity” is understood to mean the property of being deformable under the effect of a mechanical stress and of resuming its initial shape when this mechanical stress is removed.

The term “water repellency” is understood to mean the capability of droplets sliding over a support without penetrating thereinto.

The membranes obtained by the process of the invention advantageously have at least one, and preferably several, of the following characteristics:
contact angle: the coating as described is ultrahydrophobic, i.e. water in contact with this coating makes an angle of greater than 140°;
water repellency: category 5 evaluated using the ISO 4920 standard;
rubbing: abrasion resistance/reduction in rubbing (greater slip);
breathability: the breathability of the membrane of the invention is measured according to the ASTM E96 standard, method B. The coating according to the invention in no way modifies the water vapor permeability of the material on which it has been deposited;
impermeability: the water impermeability is measured according to the ISO 811 standard. A membrane is said to be water-impermeable if it is resistant to more than 100 cm of water (in general, breathable water-repellent membranes are resistant to more than 800 to 1000 cm of water). The coating of a plasma layer of the invention significantly improves the water resistance of the support layer; and
elasticity of the coating: the plasma coating retains its gas permeability, especially water vapor permeability, properties and its water impermeability properties up to elongations below 300% (for NBR substrates). The products of the prior art possess only a limited elasticity of a few tens of percent because of their continuous nature. The coating of the invention possesses a nanoscale structure enabling it to maintain ultrahydrophobic and impermeable properties up to high elongations.

The applications that the membranes of the invention may include are especially, but not limitingly, the manufacture of protective clothing, fuel cell membranes and ultrafiltration membranes.

### EXAMPLE

### Equipment and Method

Measurement Methods
Impermeability: this is measured by the resistance to water penetration according to the ISO 811 standard.
Preservation of water repellency in a stretching situation: a micrometer table is used (displacement speed of the specimen: 6.25 mm/s and displacement increment: 5 mm);
   specimen size 35 mm×32 mm with a reference zone of d=10 mm.

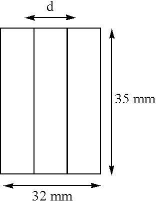

Objective: to follow the increase in distance d according to the ultrahydrophobicity of the surface.
Water repellency: spray test according to the ISO 4920 standard.

Analytical Techniques:
Analysis of the surface morphology and surface roughness:
   scanning electron microscopy: an MEB-FEG Zeiss Supra 35 instrument sold by the company Zeiss was used;
   atomic force microscopy: a Nanoscope® III instrument sold by the company Veeco was used.
Thickness of the layer:
   measured by a stylus profilometer: a Dektak® 8 instrument sold by the company Veeco was used.
Chemical composition of the layer:
   X-ray photoelectron spectroscopy: an LHS12 X-ray photoelectron spectrography (XPS) instrument sold by the company Leybold was used;
   Fourier-transform infrared spectroscopy: a Nexus® FT-IR instrument sold by the company Thermo Nicolet was used. The spectra were recorded between 4000 and 500 cm⁻¹ and accumulated 100 times with a 4 cm⁻¹ resolution.
Surface properties of the coating:
   measured by the contact angles between water and the coating. A G10 Contact Angle Measurement System sold by the company Krüss was used. The superhydrophobicity is given by measurements of contact angles by the hanging drop technique. A surface is ultrahydrophobic for water contact angles greater than 140°—the water droplet then rolling over the surface of the substrate.

### Example 1

### A—The Plasma Reactor

The plasma reactor used for obtaining ultrahydrophobic surfaces is described below:

a—The Excitation System

The generator was a Dressler® model delivering electromagnetic (13.56 MHz) waves with a power ranging between 0 and 500 W. The reflected power was adjusted so as to be minimal, using an automatic tuning box.

b—The Reactor

The reactor was an aluminum chamber 35.5 cm in diameter and 39.5 cm in depth, thus having a volume of 50 liters. It had an aluminum plate (measuring 20 cm×20 cm) serving as cathode, insulated from the rest of the chamber by a Teflon plate. The cathode was connected directly to the generator and the chamber served as anode. The plasma was created between the anode and the cathode, its intensity varying with the power and the flow rate. This reactor was provided with an optical window.

c—The Pumping System

The pumping system consisted of a 40 m³/h two-stage Edwards® vacuum pump. Two types of gauges were present on the above reactor; a piezoelectric control gauge and a capacitive process gauge (Instron®) working on the pressure scale ranging from 0 to 1 bar and from 0 to 1 torr respectively. The gas flow rate (Q) was controlled by a Bruker® flowmeter. The displayed flow rate was expressed in %. The flow rate and the pressure are linked parameters: the pressure varies slightly with the flow rate.

Four parameters to be optimized determined the surface modification of the material exposed to the plasma: the excitation power P (in W); the treatment time t (in seconds); the pressure (in mbar); and the gas flow rate Q (in sccm).

An untreated nonwoven polyester/polypropylene microfiber film (Miracloth® from Daiwabo) measuring 5 cm×5 cm was used as substrate. Tests were also carried out on an Alpex® 07I24A membrane made of polyamide and elastane comprising a polyurethane film as breathable water-repellent membrane, sold by the company Tissages de Quintenas.

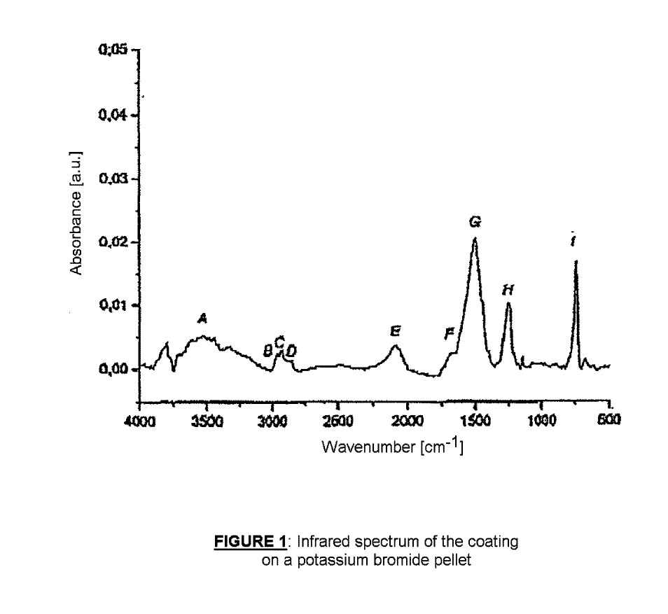

The protocol below was followed:
the film was subjected on one of its faces to a treatment using an argon plasma with a power P of 200 W for a time t of 120 s, the gas flow rate Q being 75 sccm and the pressure 0.45 mbar;
the membrane resulting from this first step was subjected on the same face to a treatment using a C₂H₂/CF₄ plasma with a power P of 100 W for a time t of 50 s, the C₂H₂ gas flow rate Q was 30 sccm, the CF₄ gas flow rate Q was 13 sccm and the pressure was 0.2 mbar;
the membrane resulting from this step was subjected on the same face to a treatment using a CF₄ plasma having a power P of 300 W for a time t of 170 s, the gas flow rate Q being 72 sccm and the pressure being 0.4 mbar; and
the coating obtained was analyzed by Fourier-transformed infrared spectroscopy: the resulting spectrum is illustrated in FIG. 1. The observed peaks are detailed in Table 1 below:

TABLE 1
Assignment of the IR peaks

| Peak reference | Wavenumber (cm⁻¹) | Peak assignment |
|---|---|---|
| A | 3635 | OH stretching from H₂O |
| B | 2956 | CH₃ asymmetric stretching |
| C | 2924 | CH₃ asymmetric stretching |
| D | 2854 | CH₃ asymmetric stretching |
| E | 2099 | C═C and R—C═CH stretching |
| F | 1674 | C═O stretching |
| G | 1487 | Aromatic C═C stretching |
| H | 1251 | C—F stretching |
| I | 1050 | CH₂—F stretching |
| J | 876 | CH₂ rocking from CH₂—F groups |
| K | 482 | CF rocking from CF₃COO groups |

Detailed XPS Analysis

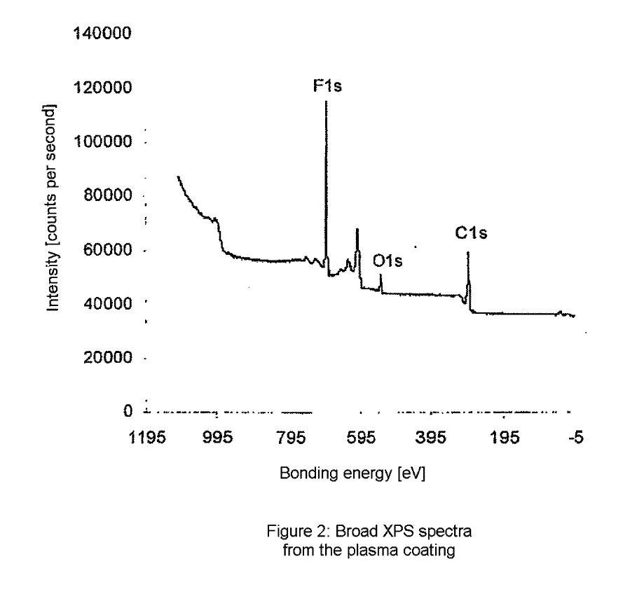

The coating consisted of carbon (C), fluorine (F) and oxygen (O). The broad spectrum of the layer is shown in FIG. 2 (coating deposited on silicon wafers).

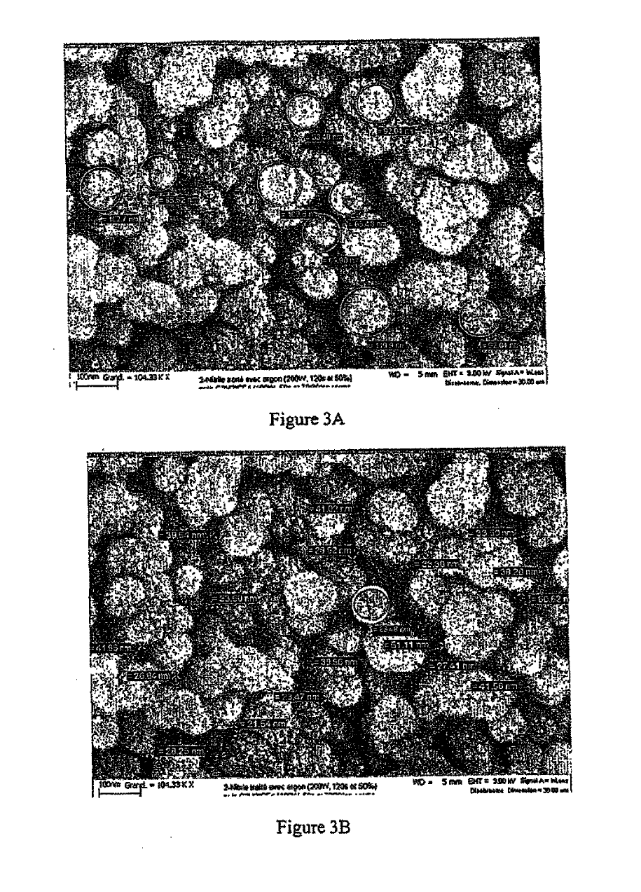

This coating comprised 63±5% carbon 31.3±5% fluorine and 5.5±5% oxygen and was essentially composed of the following bonds (FIG. 3): CF₂—CF₂ (292.7 eV) relating to the Teflon-type structure contributing to the ultrahydrophobicity of the coating; CF—CFₙ (290.5 eV); CF (287.3 eV); and C═CFₙ (285.8 eV).

Surface Roughness Measurement

The surface roughness (Ra) was obtained from (50 μm×50 μm) image scans. Each value was an average of 8 scans (for a 25 μm×25 μm window). The variations in surface roughness according to the plasma treatment are given in Table 2. The ultrahydrophobic plasma coating has a surface roughness of 139 nm, i.e. greater surface roughness than that of the substrate serving as control.

TABLE 2
Variation in roughness according to the
treatment (nitrile film substrate)

| Material | Surface roughness (nm) |
|---|---|
| Control substrate | 77 ± 21 |
| Control substrate + coating | 139 ± 34 |

Nanostructure:

The nanoporous structure of the coating was displayed using electron micrographs as shown in FIGS. 3A and 3B.

The membrane obtained had the following properties:

Breathability (Water Vapor Permeability):

The water vapor permeability was measured according to the ASTM E96B standard at 23° C. and 50% humidity. The results are given in Table 3:

TABLE 3

| Substrate | Permeability (g/m² per 24 h) |
|---|---|
| Miracloth ® substrate film | 937 ± 32 |
| Coated film from the plasma | 880 ± 26 |
| treatment | |
| ALPEX ® 07I24A membrane | 638 ± 7 |
| (85% polyamide/10% polyurethane/ | |
| 5% elastane) (breathable water- | |
| repellent membrane comprising | |
| a PU film) | |

Water Repellency

Measured according to the ISO 4920 standard:

| Substrate | Water repellency |
|---|---|
| Miracloth ® substrate film | 3 |
| Coated film from the plasma treatment | 5 |

### Example 2

An NBR (nitrile butyl rubber) membrane was used as substrate.

a—Composition

| | Parts by dry | Dispersion |
|---|---|---|
| | weight | concentration (%) |
| Carboxylated NBR | 100 | 48 |
| latex(***) | | |
| Potassium hydroxide | 0.5 | 5.0 |
| Zinc oxide | 1.5 | 53.4 |
| Sulfur | 0.85 | 50.4 |
| ZMBT(****) | 0.3 | 49.0 |
| Hydroxyethylcellulose(*) | 20 | 10 |
| Melamine-formaldehyde | 2 | 63 |
| resin(**) | | |
| NH₄Cl | 0.2 | 30 |

(*)Sold by Hercules under the reference NATROSOL 250LR;
(**)Sold by Synthron under the reference PROXM3M;
(***)NBR = acrylonitrile-butadiene rubber;
(****)ZMBT = zinc 2-mercaptobenzothiazole.
The solids content of the compostion was 29%.

Process Steps

A film was produced by dipping a former into the composition described above. The dipping operation was performed only once. The film was then dried by heating it to 50° C. and then vulcanized at 170° C. A membrane having a thickness of 60 microns was obtained.

b—The Excitation System

The generator was a Dressler model delivering electromagnetic (13.56 MHz) waves with a power ranging between 0 and 1000 W. The reflected power was adjusted so that it was minimal using an automatic tuning box. It could be used in pulsed mode.

c—The Reactor

The reactor was an aluminum chamber 40 cm in diameter and 40 cm in depth, thus having a volume of 50 liters. The cathode measured 20 cm×30 cm, the chamber serving as counter electrode (anode). This reactor was provided with an optical window.

d—The Pumping System

The pumping system consisted of a 40 m³/h two-stage Edwards® vacuum pump and a 250 m³/h Roots® pump. Two types of gauges were present on the above reactor: a piezoelectric control gauge and a capacitive process gauge (Instron®) working on a pressure scale ranging from 0 to 1 bar and 0 to 1 torr respectively. The gas flow rate (Q) was controlled by a Bruker® flowmeter. The displayed flow rate was expressed in %. The flow rate and the pressure are linked parameters, the pressure varying slightly with the flow rate.

The protocol below was followed:
the membrane was subjected on one of its faces to a treatment using an argon plasma with a power P of 200 W for a time t of 120 s, the gas flow rate Q being 75 sccm and the pressure 0.4 mbar;
the membrane obtained from this first step was subjected on the same face to a treatment using a C₂H₂/CF₄ plasma having a power P of 100 W for a time t of 50 s, the C₂H₂ gas flow rate Q was 30 sccm and the CF₄ gas flow rate Q was 13 sccm. The excitation system was in pulse mode: 1 Hz frequency and 90% duty cycle;
the membrane resulting from this step was subjected on the same face to a treatment using a CF₄ plasma having a power P of 300 W for a time t of 170 s, the gas flow rate Q being 70 sccm and the pressure 0.4 mbar.

The membrane resulting from this protocol had a very high elasticity (>250%) and also retained its hydrophobic and water vapor permeability properties for an elongation of 250%.

Results:

Contact angle: the hydrophobicity (given by measuring the contact angle of water with the surface) is given in Table 4:

TABLE 4
Water contact angle

| Material | Water contact angle |
|---|---|
| Untreated stretch film | 62.6 ± 3.6 |
| Stretch film + treatment | >140 |

Breathability of the material: this is given in Table 5.

TABLE 5

| Substrate | Permeability (g/m² per 24 h) |
|---|---|
| NBR substrate film | 590 ± 30 |
| Coated film from the | 580 ± 30 |
| plasma treatment | |

### Example 3

Contact angle measurement after various plasma treatments:

Control: NBR latex (with the composition as defined in Example 2)

Specimen 1 (comparative specimen): Control+treatment by an argon plasma having a power P of 200 W for a time t of 120 s, the gas flow rate Q being 75 sccm and the pressure 0.4 mbar+CF₄ plasma treatment: power P of 300 W for a time t of 170 s, the gas flow rate Q being 70 sccm and the pressure 0.4 mbar.

Specimen 2 (comparative example): Control+treatment by an argon plasma with a power P of 200 W for a time t of 120 s, the gas flow rate Q being 75 sccm and the pressure 0.4 mbar+treatment by a C₂H₂/CF₄ plasma with a power P of 100 W for a time t of 50 s, the C₂H₂ gas flow rate Q being 30 sccm and the CF₄ gas flow rate Q being 13 sccm. The excitation system was in pulsed mode: 1 Hz frequency and 90% duty cycle.

Specimen 3 (according to the invention): Control+treatment by an argon plasma with a power P of 200 W for a time t of 120 s, the gas flow rate Q being 75 sccm and the pressure 0.4 mbar+treatment by a C₂H₂/CF₄ plasma with a power P of 100 W for a time t of 50 s, the C₂H₂ gas flow rate Q being 30 sccm and the CF₄ gas flow rate Q being 13 sccm. The excitation system was in pulsed mode: 1 Hz frequency and 90% duty cycle+CF₄ plasma treatment: power P of 300 W for a time t of 170 s, the gas flow rate Q being 70 sccm and the pressure 0.4 mbar.

Results:

| | Control | Specimen 1 | Specimen 2 | Specimen 3 |
|---|---|---|---|---|
| Water | The droplet | 90° | 140° just after | >140° and the |
| contact | spreads out | | deposition, but | treatment is |
| angle (°) | | | the treatment is | permanent |
| | | | not permanent | |
| | | | (90° after | |
| | | | very slight | |
| | | | abrasion) | |

1. A method for manufacturing a membrane, characterized in that:
(i) a support layer consisting of a film or a membrane made of a gas-permeable material is used;
(ii) optionally, this support layer is subjected on at least one of its faces to at least one treatment chosen from:
a plasma treatment using the plasma of a gas chosen from: argon, oxygen, helium and mixtures thereof and
a chemical cleaning step;
(iii) the film or the membrane coming from step (i) or from step (ii) is subjected on the same face to a plasma treatment using a plasma of a precursor compound chosen from: a hydrocarbon gas, a fluorocarbon gas and hydrocarbon gas/fluorocarbon gas mixtures; a fluorocarbon liquid; and a fluorocarbon solid, the precursor compound being chosen in such a way that F/C<2; and
(iv) the film or the membrane coming from step (iii) is subjected on the same face to a plasma treatment using a plasma of a fluorocarbon gas, this fluorocarbon gas being chosen in such a way that it has an F/C ratio ≧2.

2. The method as claimed in claim 1, in which the plasmas are plasmas generated by a radio frequency wave.

3. The method as claimed in claim 1, in which the plasmas come from the treatment of a precursor by PECVD.

4. The method as claimed in claim 1, in which the support layer is chosen from: a membrane made of a polymer material, a nonwoven textile material, a woven or knitted fibrous material, a composite based on a polymer and at least one material chosen from natural and synthetic fibers, cellulose and cellulose derivatives.

5. The method as claimed in claim 1, in which the support layer is chosen from: membranes made of an elastomer material and membranes coming from a blend of polymers, at least one of the components of which is an elastomer.

6. The method as claimed in claim 1, in which the support layer is chosen from films or membranes that have a water vapor permeability equal to or greater than 250 g of water vapor per square meter per day, measured according to the ASTM E96 standard, method B.

7. The method as claimed in claim 1, in which the support layer is chosen from films or membranes that have a tensile set after a 50% elongation, measured according to the ISO 2285 standard, of 10% or less.

8. The method as claimed in claim 1, in which the support layer is subjected in step (ii) to an argon plasma treatment, the power P of which is between 0.1 and 2 W/cm² of useful electrode area.

9. The method as claimed in claim 1, in which the gas employed in step (iii) is a C₂H₂/CF₄ mixture, the power P of which is between 0.04 and 2 W/cm² of useful area of the cathode.

10. The method as claimed in claim 1, in which the gas or gas mixture in step (iii) is a C₂H₂/CF₄ mixture with a volume ratio such that 2≦C₂H₂/CF₄≦5.

11. The method as claimed in claim 1, in which the gas in step (iv) is CF₄ and the power P is between 0.2 and 3 W/cm² of useful area of the cathode.

12. A membrane that can be obtained by the process as claimed in claim 1, characterized in that it includes a support layer in the form of a membrane or a film made of a gas-permeable material and at least one layer of a coating consisting of a nanostructured crosslinked amorphous polymer composed of C, H, F and optionally O, the C/F molar ratio being between 1.5 and 2.5, this layer having carbon-containing functional groups, fluorine-containing functional groups and optionally carbonyl functional groups.

13. The membrane as claimed in claim 12, in which the coating layer is in the form of nanoparticles with a size of between 10 and 500 nm, preferably between 50 and 150 nm.

14. The membrane as claimed in claim 12, in which the coating layer forms a porous film with pore sizes ranging from 10 to 200 nm.

15. The membrane as claimed in claim 12, in which the thickness of the coating layer is between 20 and 1000 nm.

16. The membrane as claims in claim 12, in which the coating layer forms a porous film with pore sizes ranging from 20 to 100 nm.

17. The membrane as claimed in claim 12, in which the thickness of the coating layer is between 40 to 100 nm.
